(19) United States
(12) Patent Application Publication
(10) Pub. No.: US 2024/0318049 A1
(43) Pub. Date: Sep. 26, 2024

(54) NANO-CAPSULE, AND COMPOSITION, FILM, AND ELECTRONIC APPARATUS, INCLUDING THE SAME

(71) Applicants: Samsung Display Co., Ltd., Yongin-si (KR); Foundation of Soongsil University-Industry Cooperation, Seoul (KR)

(72) Inventors: Seungho Kim, Yongin-si (KR); Junhyup Lee, Seongnam-si (KR); Kangwoo Lee, Yongin-si (KR); Intae Son, Yongin-si (KR); Dohyun Kim, Pyeongtaek-si (KR); Jinwook Kim, Incheon (KR)

(21) Appl. No.: 18/431,243

(22) Filed: Feb. 2, 2024

(30) Foreign Application Priority Data
Mar. 24, 2023 (KR) 10-2023-0039130
May 4, 2023 (KR) 10-2023-0058492

(51) Int. Cl. C09J 11/08; B32B 7/12; C09J 7/10; C09J 7/38; C09J 11/06

(52) U.S. Cl. CPC C09J 11/08; B32B 7/12; C09J 7/10; C09J 7/385; C09J 11/06; B32B 2255/26; B32B 2307/748; B32B 2457/20; C09J 2203/326; C09J 2301/408; C09J 2301/412; C09J 2301/414; C09J 2301/502; C09J 2433/00

(57) ABSTRACT

A nanocapsule includes a core-shell structure which has a core including a thermally decomposable compound and a shell including a polymer. A composition includes the nanocapsule. A film includes a nanocapsule layer including the composition and an optically clear adhesive. An electronic apparatus includes a laminated structure including the film and a substrate.

### CROSS-REFERENCES TO RELATED APPLICATION

This application is based on and claims priority under 35 USC § 119 to Korean Patent Application Nos. 10-2023-0039130, filed on Mar. 24, 2023, and 10-2023-0058492, filed on May 4, 2023, in the Korean Intellectual Property Office, the contents of which are herein incorporated by reference in their entirety.

### BACKGROUND

### 1. Field

The present disclosure relates to nanocapsules, and a composition, a film, and an electronic apparatus, each including the same.

### 2. Description of the Related Art

In the display industry, when a display panel is bonded to a touch panel or tempered glass, an air gap can be present. When such an air gap is present, outdoor visibility and contrast ratio are decreased due to reflection of the two surfaces. To solve this problem, an optically clear adhesive (OCA) can be used to bond substrate layers to each other.

For a flexible display, defect rates can be high when an OCA is used to bond substrate layers. In addition, in the case of a flexible display, the prices of the externally disposed touch panel and protective substrate are high. Therefore, methods have been developed for reuse of the materials. Reuse methods include a method for electrically decomposing an adhesive film by voltage, a method for separating an adhesive film using photoisomerization by ultraviolet (UV) light, and a method for separating the adhesive film using thermally expandable microcapsules.

In the case of films, which can be electrically decomposed by voltage, applying voltage can induce debonding of an adhesive material. However, due to the high voltages (50 V to 500 V), the circuit of a panel adhered to a film can be damaged. In addition, this method is applicable only to conductive metal substrates. Furthermore, when a room-temperature curing type epoxy adhesive, such as polydimethylsiloxane (PDMS) or polyethylene glycol (PEG), is used, the optical transmittance is lowered.

Film separation technology using photoisomerization by UV light is based on azobenzene-based and acrylate-based resin materials. This method induces photoisomerization of azobenzene by UV light and debonds via phase transition (solid→liquid). Because azobenzene is in the form of orange-red crystals or dark brown solids, the transmittance is decreased. Also, optional thin-film separation by the UV process remains limited.

For the method of inducing debonding of films using thermally expandable microcapsules, microcapsules have a particle size of about 10 micrometers (μm) to about 16 μm and a maximum thermal expansion temperature of about 120° C. to about 135° C. Due to the larger micro size, the optical transmittance is lowered. Furthermore, due to the high temperatures of the process, the method is generally not useful for panels.

Thus, a need remains for improved methods for inducing film debonding.

### SUMMARY

One or more embodiments includes nanocapsules that induce film debonding at a mild temperature, and a composition, a film, and an electronic apparatus, each including the same.

Additional aspects will be set forth in part in the description which follows and, in part, will be apparent from the description, or may be learned by practice of the presented embodiments of the disclosure.

According to one or more embodiments, a nanocapsule having a core-shell structure includes a core containing a thermally decomposable compound and a shell containing a polymer.

According to one or more embodiments, a composition includes the nanocapsule, a cross-linkable monomer, and an initiator.

According to one or more embodiments, a film includes a nanocapsule layer including the composition and an optically clear adhesive (OCA).

According to one or more embodiments, an electronic apparatus includes a first substrate, a second substrate opposed to the first substrate, and a film disposed between the first substrate and the second substrate, wherein the film may include a nanocapsule layer including the composition and an OCA.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic diagram of an exemplary embodiment of the structure of a nanocapsule;

FIG. 2 is a schematic diagram of an exemplary embodiment of a laminated structure of a film and substrates;

FIG. 3 is an electron micrograph image of an exemplary embodiment of the nanocapsules; and

FIG. 4 is an image of an exemplary embodiment of the gas generation ability by heat treatment of the nanocapsules.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Correspondingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

It will be understood that when an element is referred to as being “on” another element, it can be directly on the other element or intervening elements may be present therebetween In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a,” “an,” “the,” and “at least one” do not denote a limitation of quantity, and are intended to cover both the singular and plural, unless the context clearly indicates otherwise. For example, “an element” has the same meaning as “at least one element,” unless the context clearly indicates otherwise.

“Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded Thus, the regions illustrated in the figures are schematic in nature and their shapes are not intended to illustrate the precise shape of a region and are not intended to limit the scope of the present claims.

A nanocapsule according to one aspect may have a core-shell structure including: a core including a thermally decomposable compound and a shell including a polymer.

In an embodiment, the thermally decomposable compound may include a moiety that decomposes at a temperature of about 50° C. to about 200° C. to generate a gas. For example, the thermally decomposable compound may include a moiety that decomposes at a temperature of about 80° C. to about 150° C. to generate a gas. For example, the thermally decomposable compound may include a moiety that decomposes at a temperature of about 90° C. to about 120° C. to generate a gas.

In an embodiment, the moiety may include at least one of a hydrazide group, a hydroxyl group, or a combination thereof.

For example, the thermally decomposable compound may include R¹CO—NHNH₂, R²SO₂—NHNH₂, R³R⁴P(O)—NHNH₂, M(OH)ₘ, or a combination thereof, wherein
M may be a metal,
m may be an integer from 1 to 5,
R¹ to R⁴ may each independently be a C₁-C₆₀ alkyl group unsubstituted or substituted with at least one R₁₀ₐ, a C₂-C₆₀ alkenyl group unsubstituted or substituted with at least one R₁₀ₐ, a C₂-C₆₀ alkynyl group unsubstituted or substituted with at least one R₁₀ₐ, a C₁-C₆₀ alkoxy group unsubstituted or substituted with at least one R₁₀ₐ, a C₃-C₆₀ carbocyclic group unsubstituted or substituted with at least one R₁₀ₐ, or a C₁-C₆₀ heterocyclic group unsubstituted or substituted with at least one R₁₀ₐ,
R₁₀ₐ may be:
deuterium (-D), —F, —Cl, —Br, —I, a hydroxyl group, a cyano group, or a nitro group;
a C₁-C₆₀ alkyl group, a C₂-C₆₀ an alkenyl group, a C₂-C₆₀ alkynyl group, or a C₁-C₆₀ alkoxy group, each unsubstituted or substituted with deuterium, —F, —Cl, —Br, —I, a hydroxyl group, a cyano group, a nitro group, a C₅-C₆₀ carbocyclic group, a C₁-C₆₀ heterocyclic group, a C₆-C₆₀ aryloxy group, a C₆-C₆₀ arylthio group, a C₇-C₆₀ arylalkyl group, a C₂-C₆₀ heteroarylalkyl group, —Si(Q₁₁)(Q₁₂)(Q₁₃), —N(Q₁₁)(Q₁₂), —B(Q₁₁)(Q₁₂), —C(═O)(Q₁₁), —S(═O)₂(Q₁₁), —P(═O)(Q₁₁)(Q₁₂), or a combination thereof;
a C₃-C₆₀ carbocyclic group, a C₁-C₆₀ heterocyclic group, a C₆-C₆₀ aryloxy group, a C₆-C₆₀ arylthio group, a C₇-C₆₀ arylalkyl group, or a C₂-C₆₀ heteroarylalkyl group, each unsubstituted or substituted with deuterium, —F, —Cl, —Br, —I, a hydroxyl group, a cyano group, a nitro group, a C₁-C₆₀ alkyl group, a C₂-C₆₀ alkenyl group, a C₂-C₆₀ alkynyl group, a C₁-C₆₀ alkoxy group, a C₃-C₆₀ carbocyclic group, a C₁-C₆₀ heterocyclic group, a C₆-C₆₀ aryloxy group, a C₆-C₆₀ arylthio group, a C₇-C₆₀ arylalkyl group, a C₂-C₆₀ heteroarylalkyl group, —Si(Q₂₁)(Q₂₂)(Q₂₃), —N(Q₂₁)(Q₂₂), —B(Q₂₁)(Q₂₂), —C(═O)(Q₂₁), —S(═O)₂(Q₂₁), —P(═O)(Q₂₁)(Q₂₂), or a combination thereof; or
—Si(Q₃₁) (Q₃₂)(Q₃₃), —N(Q₃₁)(Q₃₂), —B(Q₃₁)(Q₃₂), —C(═O)(Q₃₁), —S(═O)₂(Q₃₁), or —P(═O)(Q₃₁)(Q₃₂), wherein
Q₁₁ to Q₁₃, Q₂₁ to Q₂₃, and Q₃₁ to Q₃₃ may each independently be: hydrogen; deuterium; —F; —Cl; —Br; —I; a hydroxyl group; a cyano group; a nitro group; a C₁-C₆₀ alkyl group; a C₂-C₆₀ alkenyl group; a C₂-C₆₀ alkynyl group; a C₁-C₆₀ alkoxy group; or a C₃-C₆₀ carbocyclic group, a C₁-C₆₀ heterocyclic group, a C₇-C₆₀ arylalkyl group, or a C₂-C₆₀ heteroarylalkyl group, each unsubstituted or substituted with deuterium, —F, cyano group, a C₁-C₆₀ alkyl group, a C₁-C₆₀ alkoxy group, a phenyl group, a biphenyl group, or a combination thereof.

For example, M may be a transition metal. For example, M may be zinc (Zn).

For example, m may be an integer of 1 to 3. For example, m may be 1 or 2.

In an embodiment, the thermally decomposable compound may include benzenesulfonyl hydrazide, p-toluenesulfonyl hydrazide, acetylhydrazide, 2,4,6-triisopropylbenzenesulfonylhydrazide, zinc hydroxide, or a combination thereof.

For example, Zn(OH)₂ may be decomposed into ZnO and H₂O(g) by heating at the temperature of about 100° C. to about 110° C.

In an embodiment, the polymer of the shell may include a polymer formed from a monomer including a vinyl group.

For example, the polymer of the shell may include a polymer formed from monomers including methyl methacrylate, acrylonitrile, 2-ethylhexyl acrylate, butyl acrylate, vinyl acetate, ethyl acrylate, methyl acrylate, benzyl acrylate, phenoxyethyl acrylate, acrylic acid, hydroxyethyl methacrylate, glycidyl methacrylate, acetoacetoxyethyl methacrylate, 2-hydroxyethyl acrylate, isobornyl acrylate, octadecyl methacrylate, or a combination thereof. The polymer formed from the monomer has a refractive index similar to that of an optically clear adhesive (OCA). Accordingly, good optical properties may be maintained.

In an embodiment, the polymer of the shell may be a non-crosslinkable polymer.

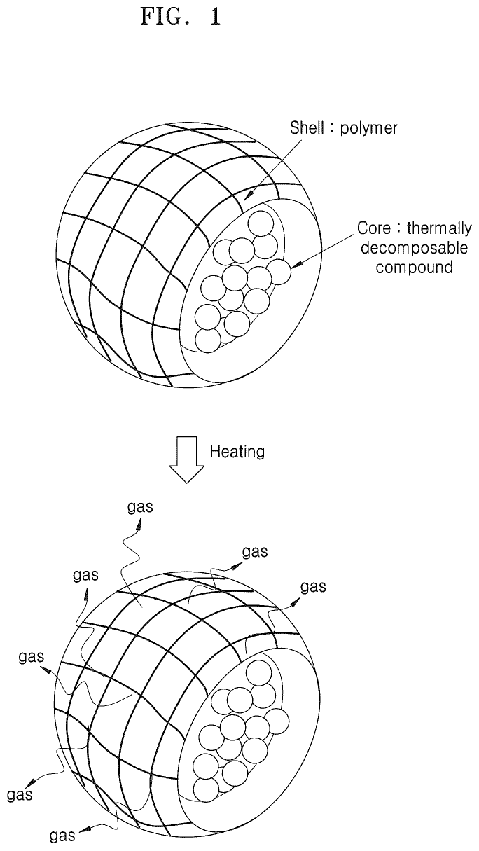

FIG. 1 is a diagram schematically showing the structure of a nanocapsule according to an exemplary embodiment.

Referring to FIG. 1, the thermally decomposable compound included in the core is decomposed by applied heat to generate a gas, and the gas is ejected through a gap in the shell.

For example, the gas may be nitrogen gas (N₂) or water vapor.

The polymer of the shell is a non-crosslinkable polymer and may have gaps through which gas, for example, molecular nitrogen or water vapor, may escape. When the polymer of the shell is a crosslinkable polymer, it may be difficult to release gas generated by thermal decomposition.

The thickness of the shell may be, for example, about 10 nanometers (nm) to about 100 nm. The thickness of the shell may be, for example, about 20 nm to about 80 nm. When the thickness of the shell is within the range, heat transfer to the core and ejection of the generated gas may be facilitated.

In an embodiment, the nanocapsule may have the size of about 100 nm to about 500 nm. When the size of the nanocapsule is within the range, good optical properties may be maintained.

A composition according to another aspect may include the nanocapsule, a crosslinkable monomer, and an initiator.

In an embodiment, the crosslinkable monomer may include a vinyl group.

In an embodiment, the amount of the nanocapsule may be about 0.1 weight percent (wt %) to about 10 wt % (based on a total weight of the composition). When the amount of the nanocapsule is less than 0.1 wt %, the debonding of the film containing the nanocapsule layer including the composition may be difficult due to insufficient gas generation. When the amount of nanocapsules exceeds 10 wt %, there can be difficulties adhering the composition to a substrate.

In an embodiment, the crosslinkable monomer included in the composition may include 2-ethylhexyl acrylate, butyl acrylate, vinyl acetate, methyl methacrylate, ethyl acrylate, methyl acrylate, benzyl acrylate, phenoxyethyl acrylate, acrylic acid, hydroxyethyl methacrylate, glycidyl methacrylate, acetoacetoxyethyl methacrylate, 2-hydroxyethyl acrylate, isobornyl acrylate, or a combination thereof.

The initiator may be, for example, a photoinitiator or a thermal initiator. The range of the amount of the initiator may be the range of the amount of generally used in polymer polymerization.

In an embodiment, the initiator may include diphenyl(2,4,6-trimethylbenzoyl)phosphine oxide, 4-acryloxybenzophenone, 2,2-dimethoxy-2-phenylacetophenone, 2-hydroxy-2-methyl-1-phenyl-1-propan-1-one, ethyl(2,4,6-trimethylbenzoyl)phenyl phosphinate, bisacylphosphine oxide, or a combination thereof.

A film according to another aspect may include a nanocapsule layer including the composition and an OCA.

In an embodiment, the nanocapsule layer may have a thickness of about 1 μm to about 30 μm.

When the thickness of the nanocapsule layer is less than 1 μm, the quantity of gas generated by heating can be insufficient to efficiently debond the film. When the thickness of the nanocapsule layer exceeds 30 μm, gas may collect in the middle of the nanocapsule layer and the debonding of the film may not be efficient.

In an embodiment, the thickness of the film may be about 20 μm to about 200 μm. When the thickness of the film is within the range, the debonding from the substrate can proceed efficiently and the light transmittance can remain satisfactory (e.g., an optical transmittance of greater than 90% compared to pure OCA).

An electronic apparatus according to another aspect includes: a first substrate; a second substrate opposed to the first substrate; and a film disposed between the first substrate and the second substrate, wherein the film includes a nanocapsule layer and an OCA.

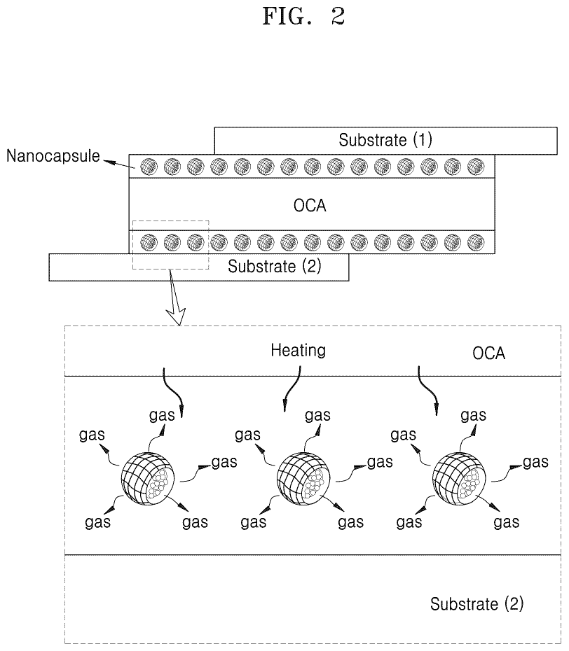

FIG. 2 is a diagram schematically showing a laminated structure of a film and substrates according to an exemplary embodiment. Referring to FIG. 2, the OCA is located between two nanocapsule layers. However, it is not limited thereto, and the nanocapsule layer may be located only on either the first substrate or the second substrate.

In an embodiment, the nanocapsule layer may directly contact at least one of a first substrate 1 and a second substrate 2. In such embodiments, there may be no intervening layers between the nanocapsule layer and the first substrate and/or no intervening layers between the nanocapsule layer and the second substrate.

For example, the first substrate and the second substrate may each independently include a display panel, a touch panel, a polarizing plate, or tempered glass.

For example, the electronic apparatus may include a laminated structure of an OCA film/display panel. In this regard, the OCA film may include a nanocapsule layer including the composition, and the nanocapsule layer may directly physically contact the display panel. When rework of the laminated structure of the OCA film/display panel is desired, the thermally decomposable compound contained in the nanocapsule is decomposed by applying heat (for example, about 100° C. to about 110° C.) to generate a gas, and the debonding of the OCA film and the display panel is facilitated.

For example, the electronic apparatus may include a laminated structure of display panel/OCA film/tempered glass. In this regard, the OCA film may include a nanocapsule layer including the composition, and the nanocapsule layer may be one layer or two layers. The nanocapsule layer may directly physically contact the display panel and/or the tempered glass. When rework of the laminated structure of the display panel/OCA film/tempered glass is desired, by applying heat (for example, about 100° C. to about 110° C.), the thermally decomposable compound contained in the nanocapsule is decomposed and gas is generated, and debonding of the display panel and OCA film and/or debonding of OCA film and tempered glass are facilitated.

For example, when the laminated structure is reworked, the thermally decomposable compound of the nanocapsule included in the laminated structure may be absent because of decomposition of the thermally decomposable compound. When the laminated structure has not been reworked, the thermally decomposable compound of the nanocapsule contained in the laminated structure remains but does not decompose under operating temperature conditions of the electronic apparatus.

In another embodiment, when the electronic apparatus includes a laminated structure of display panel/OCA film/tempered glass, and the OCA film includes a nanocapsule, when heat is applied to the electronic apparatus in the A/S (after service) process (for example, about 100° C. to about 110° C.), the thermally decomposable compound contained in the nanocapsule is decomposed and gas is generated, and the debonding of the display panel and OCA film, and/or the debonding of OCA film and tempered glass may be facilitated. Therefore, for example, when only the tempered glass is damaged without damaging the display panel, costs can be reduced by easily replacing only the OCA film and the tempered glass.

### DEFINITION OF TERMS

The term “a C₅-C₆₀ carbocyclic group” as used herein refers to a cyclic group having 3 to 60 carbon atoms consisting only of carbon as a ring-forming atom, and the term “a C₁-C₆₀ heterocyclic group” as used herein refers to a cyclic group having 1 to 60 carbon atoms further including a hetero atom other than carbon as a ring-forming atom. Each of the C₃-C₆₀ carbocyclic group and the C₁-C₆₀ heterocyclic group may be a monocyclic group consisting of one ring or a polycyclic group in which two or more rings are condensed with each other. For example, the number of ring-forming atoms in the C₁-C₆₀ heterocyclic group may be 3 to 61.

The term “the cyclic group” as used herein includes both the C₃-C₆₀ carbocyclic group and the C₁-C₆₀ heterocyclic group.

The term “the πelectron-rich C₃-C₆₀ cyclic group” as used herein refers to a cyclic group having 3 to 60 carbon atoms and not including *—N═*′ as a ring-forming moiety, and the term “πelectron-deficient nitrogen-containing C₁-C₆₀ cyclic group” used herein refers to a heterocyclic group having 1 to 60 carbon atoms including *—N′ as a ring-forming moiety.

For example, the C₃-C₆₀ carbocyclic group may be i) Group T1 or ii) a condensed cyclic group in which two or more of Group T1 are condensed with each other (for example, a cyclopentadiene group, an adamantane group, a norbornane group, a benzene group, a pentalene group, a naphthalene group, an azulene group, an indacene group, an acenaphthylene group, a phenalene group, a phenanthrene group, an anthracene group, a fluoranthene group, a triphenylene group, a pyrene group, a chrysene group, a perylene group, a pentaphene group, a heptalene group, a naphthacene group, a picene group, a hexacene group, a pentacene group, a rubicene group, a coronene group, an ovalene group, an indene group, a fluorene group, a spiro-bifluorene group, a benzofluorene group, an indenophenanthrene group, or an indenoanthracene group,
the C₁-C₆₀ heterocyclic group may be i) Group T2, ii) a condensed cyclic group in which two or more of Group T2 are condensed with each other, or iii) a condensed cyclic group in which at least one Group T2 and at least one Group T1 are condensed with each other (for example, a pyrrole group, a thiophene group, a furan group, an indole group, a benzoindole group, a naphthoindole group, an isoindole group, a benzoisoindole group, a naphthoisoindole group, a benzosilole group, a benzothiophene group, a benzofuran group, a carbazole group, a dibenzosilole group, a dibenzothiophene group, a dibenzofuran group, an indenocarbazole group, an indolocarbazole group, a benzofurocarbazole group, a benzothienocarbazole group, a benzosilolocarbazole group, a benzoindolocarbazole group, a benzocarbazole group, a benzonaphthofuran group, a benzonaphthothiophene group, a benzonaphthosilole group, a benzofurodibenzofuran group, a benzofurodibenzothiophene group, a benzothienodibenzothiophene group, a pyrazole group, an imidazole group, a triazole group, an oxazole group, an isoxazole group, an oxadiazole group, a thiazole group, an isothiazole group, a thiadiazole group, a benzopyrazole group, a benzimidazole group, a benzoxazole group, a benzoisoxazole group, a benzothiazole group, a benzoisothiazole group, a pyridine group, a pyrimidine group, a pyrazine group, a pyridazine group, a triazine group, a quinoline group, an isoquinoline group, a benzoquinoline group, a benzoisoquinoline group, a quinoxaline group, a benzoquinoxaline group, a quinazoline group, a benzoquinazoline group, a phenanthroline group, a cinnoline group, a phthalazine group, a naphthyridine group, an imidazopyridine group, an imidazopyrimidine group, an imidazotriazine group, an imidazopyrazine group, an imidazopyridazine group, an azacarbazole group, an azafluorene group, an azadibenzosilole group, an azadibenzothiophene group, an azadibenzofuran group, or the like),
the πelectron-rich C₅-C₆₀ cyclic group may be i) Group T1, ii) a condensed cyclic group in which two or more of Group T1 are condensed with each other, iii) Group T3, iv) a condensed cyclic group in which two or more of Group T3 are condensed with each other, or v) a condensed cyclic group in which at least one Group T3 and at least one Group T1 are condensed with each other (for example, the C₃-C₆₀ carbocyclic group, a 1H-pyrrole group, a silole group, a borole group, a 2H-pyrrole group, a 3H-pyrrole group, a thiophene group, a furan group, an indole group, a benzoindole group, a naphthoindole group, an isoindole group, a benzoisoindole group, a naphthoisoindole group, a benzosilole group, a benzothiophene group, a benzofuran group, a carbazole group, a dibenzosilole group, a dibenzothiophene group, a dibenzofuran group, an indenocarbazole group, an indolocarbazole group, a benzofurocarbazole group, a benzothienocarbazole group, a benzosilolocarbazole group, a benzoindolocarbazole group, a benzocarbazole group, a benzonaphthofuran group, a benzonaphthothiophene group, a benzonaphthosilole group, a benzofurodibenzofuran group, a benzofurodibenzothiophene group, a benzothienodibenzothiophene group, or the like),
the πelectron-deficient nitrogen-containing C₁-C₆₀ cyclic group may be i) Group T4, ii) a condensed cyclic group in which two or more of Group T4 are condensed with each other, iii) a condensed cyclic group in which at least one Group T4 and at least one Group T1 are condensed with each other, iv) a condensed cyclic group in which at least one Group T4 and at least one Group T3 are condensed with each other, or v) a condensed cyclic group in which at least one Group T4, at least one Group T1, and at least one Group T3 are condensed with one another (for example, a pyrazole group, an imidazole group, a triazole group, an oxazole group, an isoxazole group, an oxadiazole group, a thiazole group, an isothiazole group, a thiadiazole group, a benzopyrazole group, a benzimidazole group, a benzoxazole group, a benzoisoxazole group, a benzothiazole group, a benzoisothiazole group, a pyridine group, a pyrimidine group, a pyrazine group, a pyridazine group, a triazine group, a quinoline group, an isoquinoline group, a benzoquinoline group, a benzoisoquinoline group, a quinoxaline group, a benzoquinoxaline group, a quinazoline group, a benzoquinazoline group, a phenanthroline group, a cinnoline group, a phthalazine group, a naphthyridine group, an imidazopyridine group, an imidazopyrimidine group, an imidazotriazine group, an imidazopyrazine group, an imidazopyridazine group, an azacarbazole group, an azafluorene group, an azadibenzosilole group, an azadibenzothiophene group, an azadibenzofuran group, and the like),
Group T1 may include a cyclopropane group, a cyclobutane group, a cyclopentane group, a cyclohexane group, a cycloheptane group, a cyclooctane group, a cyclobutene group, a cyclopentene group, a cyclopentadiene group, a cyclohexene group, a cyclohexadiene group, a cycloheptene group, an adamantane group, a norbornane (or bicyclo[2.2.1]heptane) group, a norbornene group, a bicyclo[1.1.1]pentane group, a bicyclo[2.1.1]hexane group, a bicyclo[2.2.2]octane group, or a benzene group,
Group T2 may include a furan group, a thiophene group, a 1H-pyrrole group, a silole group, a borole group, a 2H-pyrrole group, a 3H-pyrrole group, an imidazole group, a pyrazole group, a triazole group, a tetrazole group, an oxazole group, an isoxazole group, an oxadiazole group, a thiazole group, an isothiazole group, a thiadiazole group, an azasilole group, an azaborole group, a pyridine group, a pyrimidine group, a pyrazine group, a pyridazine group, a triazine group, a tetrazine group, a pyrrolidine group, an imidazolidine group, a dihydropyrrole group, a piperidine group, a tetrahydropyridine group, a dihydropyridine group, a hexahydropyrimidine group, a tetrahydropyrimidine group, a dihydropyrimidine group, a piperazine group, a tetrahydropyrazine group, a dihydropyrazine group, a tetrahydropyridazine group, or a dihydropyridazine group,
Group T3 may include a furan group, a thiophene group, a 1H-pyrrole group, a silole group, or a borole group, and
Group T4 may include a 2H-pyrrole group, a 3H-pyrrole group, an imidazole group, a pyrazole group, a triazole group, a tetrazole group, an oxazole group, an isoxazole group, an oxadiazole group, a thiazole group, an isothiazole group, a thiadiazole group, an azasilole group, an azaborole group, a pyridine group, a pyrimidine group, a pyrazine group, a pyridazine group, a triazine group, or a tetrazine group.

The terms “the cyclic group, the C₃-C₆₀ carbocyclic group, the C₁-C₆₀ heterocyclic group, the πelectron-rich C₃-C₆₀ cyclic group, or the πelectron-deficient nitrogen-containing C₁-C₆₀ cyclic group” as used herein refer to a group condensed to any cyclic group, a monovalent group, or a polyvalent group (for example, a divalent group, a trivalent group, a tetravalent group, etc.) according to the structure of a formula for which the corresponding term is used. For example, the “benzene group” may be a benzo group, a phenyl group, a phenylene group, or the like, which may be easily understood by one of ordinary skill in the art according to the structure of a formula including the “benzene group.”

Examples of the monovalent C₃-C₆₀ carbocyclic group and the monovalent C₁-C₆₀ heterocyclic group may include a C₃-C₁₀ cycloalkyl group, a C₁-C₁₀ heterocycloalkyl group, a C₃-C₁₀ cycloalkenyl group, a C₂-C₁₀ heterocycloalkenyl group, a C₆-C₆₀ aryl group, a C₁-C₆₀ heteroaryl group, a monovalent non-aromatic condensed polycyclic group, and a monovalent hetero-condensed polycyclic group. Examples of the divalent C₃-C₆₀ carbocyclic group and the divalent C₁-C₆₀ heterocyclic group may include a C₃-C₁₀ cycloalkylene group, a C₁-C₁₀ heterocycloalkylene group, a C₃-C₁₀ cycloalkenylene group, a C₁-C₁₀ heterocycloalkenylene group, a C₆-C₆₀ arylene group, a C₁-C₆₀ heteroarylene group, a divalent non-aromatic condensed polycyclic group, and a divalent non-aromatic hetero-condensed polycyclic group.

The term “C₁-C₆₀ alkyl group” as used herein refers to a linear or branched aliphatic hydrocarbon monovalent group that has one to sixty carbon atoms, and specific examples thereof include a methyl group, an ethyl group, an n-propyl group, an isopropyl group, an n-butyl group, a sec-butyl group, an isobutyl group, a tert-butyl group, an n-pentyl group, a tert-pentyl group, a neopentyl group, an isopentyl group, a sec-pentyl group, a 3-pentyl group, a sec-isopentyl group, an n-hexyl group, an isohexyl group, a sec-hexyl group, a tert-hexyl group, an n-heptyl group, an isoheptyl group, a sec-heptyl group, a tert-heptyl group, an n-octyl group, an isooctyl group, a sec-octyl group, a tert-octyl group, an n-nonyl group, an isononyl group, a sec-nonyl group, a tert-nonyl group, an n-decyl group, an isodecyl group, a sec-decyl group, and a tert-decyl group. The term “C₁-C₆₀ alkylene group” as used herein refers to a divalent group having the same structure as the C₁-C₆₀ alkyl group.

The term “C₂-C₆₀ alkenyl group” as used herein refers to a monovalent hydrocarbon group having at least one carbon-carbon double bond in the middle or at the terminus of the C₂-C₆₀ alkyl group, and examples thereof are an ethenyl group, a propenyl group, a butenyl group, and the like. The term “C₂-C₆₀ alkenylene group” as used herein refers to a divalent group having the same structure as the C₂-C₆₀ alkenyl group.

The term “C₂-C₆₀ alkynyl group” as used herein refers to a monovalent hydrocarbon group having at least one carbon-carbon triple bond in the middle or at the terminus of the C₂-C₆₀ alkyl group, and examples thereof are an ethynyl group, a propynyl group, and the like. The term “C₂-C₆₀ alkynylene group” as used herein refers to a divalent group having the same structure as the C₂-C₆₀ alkynyl group.

The term “C₁-C₆₀ alkoxy group” as used herein refers to a monovalent group represented by —OA₁₀₁ (wherein A₁₀₁ is the C₁-C₆₀ alkyl group), and examples thereof are a methoxy group, an ethoxy group, an isopropyloxy group, and the like.

The term “C₃-C₁₀ cycloalkyl group” as used herein refers to a monovalent saturated hydrocarbon monocyclic group including 3 to 10 carbon atoms. Examples of the C₃-C₁₀ cycloalkyl group as used herein include a cyclopropyl group, a cyclobutyl group, a cyclopentyl group, a cyclohexyl group, a cycloheptyl group, a cyclooctyl group, an adamantyl group, a norbornyl (bicyclo[2.2.1]heptyl) group, a bicyclo[1.1.1]pentyl group, a bicyclo[2.1.1]hexyl group, or a bicyclo[2.2.2]octyl group. The term “C₃-C₁₀ cycloalkylene group” as used herein refers to a divalent group having the same structure as the C₃-C₁₀ cycloalkyl group.

The term “C₁-C₁₀ heterocycloalkyl group” as used herein refers to a monovalent cyclic group of 1 to 10 carbon atoms, further including, in addition to carbon atoms, at least one heteroatom, as ring-forming atoms, and examples thereof are a 1,2,3,4-oxatriazolidinyl group, a tetrahydrofuranyl group, a tetrahydrothiophenyl group, and the like. The term “C₁-C₁₀ heterocycloalkylene group” as used herein refers to a divalent group having the same structure as the C₁-C₁₀ heterocycloalkyl group.

The term “C₃-C₁₀ cycloalkenyl group” as used herein refers to a monovalent cyclic group that has three to ten carbon atoms and at least one carbon-carbon double bond in the ring thereof and no aromaticity, and examples thereof are a cyclopentenyl group, a cyclohexenyl group, a cycloheptenyl group, and the like. The term “C₃-C₁₀ cycloalkenylene group” as used herein refers to a divalent group having the same structure as the C₃-C₁₀ cycloalkenyl group.

The term “C₂-C₁₀ heterocycloalkenyl group” as used herein refers to a monovalent cyclic group of 1 to 10 carbon atoms, further including, in addition to carbon atoms, at least one heteroatom, as ring-forming atoms, and having at least one carbon-carbon double bond in the cyclic structure thereof. Examples of the C₂-C₁₀ heterocycloalkenyl group are a 4,5-dihydro-1,2,3,4-oxatriazolyl group, a 2,3-dihydrofuranyl group, a 2,3-dihydrothiophenyl group, and the like. The term “C₁-C₁₀ heterocycloalkenylene group” as used herein refers to a divalent group having the same structure as the C₂-C₁₀ heterocycloalkenyl group.

The term “C₆-C₆₀ aryl group” as used herein refers to a monovalent group having a carbocyclic aromatic system of 6 to 60 carbon atoms, and the term “C₆-C₆₀ arylene group” as used herein refers to a divalent group having a carbocyclic aromatic system of 6 to 60 carbon atoms. Examples of the C₆-C₆₀ aryl group are a phenyl group, a pentalenyl group, a naphthyl group, an azulenyl group, an indacenyl group, an acenaphthyl group, a phenalenyl group, a phenanthrenyl group, an anthracenyl group, a fluoranthenyl group, a triphenylenyl group, a pyrenyl group, a chrysenyl group, a perylenyl group, a pentaphenyl group, a heptalenyl group, a naphthacenyl group, a picenyl group, a hexacenyl group, a pentacenyl group, a rubicenyl group, a coronenyl group, an ovalenyl group, and the like. When the C₆-C₆₀ aryl group and the C₆-C₆₀ arylene group each include two or more rings, the rings may be condensed with each other.

The term “C₁-C₆₀ heteroaryl group” as used herein refers to a monovalent group having a heterocyclic aromatic system of 1 to 60 carbon atoms, further including, in addition to carbon atoms, at least one heteroatom, as ring-forming atoms. The term “C₁-C₆₀ heteroarylene group” as used herein refers to a divalent group having a heterocyclic aromatic system of 1 to 60 carbon atoms, further including, in addition to carbon atoms, at least one heteroatom, as ring-forming atoms. Examples of the C₁-C₆₀ heteroaryl group are a pyridinyl group, a pyrimidinyl group, a pyrazinyl group, a pyridazinyl group, a triazinyl group, a quinolinyl group, a benzoquinolinyl group, an isoquinolinyl group, a benzoisoquinolinyl group, a quinoxalinyl group, a benzoquinoxalinyl group, a quinazolinyl group, a benzoquinazolinyl group, a cinnolinyl group, a phenanthrolinyl group, a phthalazinyl group, and a naphthyridinyl group. When the C₁-C₆₀ heteroaryl group and the C₁-C₆₀ heteroarylene group each include two or more rings, the rings may be condensed with each other.

The term “monovalent non-aromatic condensed polycyclic group” as used herein refers to a monovalent group (for example, having 8 to 60 carbon atoms) having two or more rings condensed to each other, only carbon atoms as ring-forming atoms, and no aromaticity in its entire molecular structure. Examples of the monovalent non-aromatic condensed polycyclic group are an indenyl group, a fluorenyl group, a spiro-bifluorenyl group, a benzofluorenyl group, an indenophenanthrenyl group, an indeno anthracenyl group, and the like. The term “divalent non-aromatic condensed polycyclic group” as used herein refers to a divalent group having the same structure as the monovalent non-aromatic condensed polycyclic group described above.

The term “monovalent non-aromatic hetero-condensed polycyclic group” as used herein refers to a monovalent group (for example, having 1 to 60 carbon atoms) having two or more rings condensed to each other, further including, in addition to carbon atoms, at least one heteroatom, as ring-forming atoms, and having non-aromaticity in its entire molecular structure. Examples of the monovalent non-aromatic condensed heteropolycyclic group include a pyrrolyl group, a thiophenyl group, a furanyl group, an indolyl group, a benzoindolyl group, a naphtho indolyl group, an isoindolyl group, a benzoisoindolyl group, a naphthoisoindolyl group, a benzosilolyl group, a benzothiophenyl group, a benzofuranyl group, a carbazolyl group, a dibenzosilolyl group, a dibenzothiophenyl group, a dibenzofuranyl group, an azacarbazolyl group, an azafluorenyl group, an azadibenzosilolyl group, an azadibenzothiophenyl group, an azadibenzofuranyl group, a pyrazolyl group, an imidazolyl group, a triazolyl group, a tetrazolyl group, an oxazolyl group, an isoxazolyl group, a thiazolyl group, an isothiazolyl group, an oxadiazolyl group, a thiadiazolyl group, a benzopyrazolyl group, a benzimidazolyl group, a benzoxazolyl group, a benzothiazolyl group, a benzoxadiazolyl group, a benzothiadiazolyl group, an imidazopyridinyl group, an imidazopyrimidinyl group, an imidazotriazinyl group, an imidazopyrazinyl group, an imidazopyridazinyl group, an indenocarbazolyl group, an indolocarbazolyl group, a benzofurocarbazolyl group, a benzothienocarbazolyl group, a benzosilolocarbazolyl group, a benzoindolocarbazolyl group, a benzocarbazolyl group, a benzonaphthofuranyl group, benzonaphthothiophenyl group, a benzonaphthosilolyl group, a benzofurodibenzofuranyl group, a benzofurodibenzothiophenyl group, and a benzothienodibenzothiophenyl group. The term “divalent non-aromatic hetero-condensed polycyclic group” as used herein refers to a divalent group having the same structure as the monovalent non-aromatic hetero-condensed polycyclic group described above.

The term “C₆-C₆₀ aryloxy group” as used herein indicates —OA₁₀₂ (wherein A₁₀₂ is the C₆-C₆₀ aryl group), and the term “C₆-C₆₀ arylthio group” as used herein indicates —SA₁₀₃ (wherein A₁₀₃ is the C₆-C₆₀ aryl group).

The term “C₇-C₆₀ arylalkyl group” as used herein refers to -A₁₀₄A₁₀₅ (wherein A₁₀₄ is a C₁-C₅₄ alkylene group, and A₁₀₅ is a C₆-C₅₉ aryl group), and the term “C₂-C₆₀ heteroarylalkyl group” as used herein refers to -A₁₀₆A₁₀₇ (wherein A₁₀₆ is a C₁-C₅₉ alkylene group, and A₁₀₇ is a C₁-C₅₉ heteroaryl group).

The term “R₁₀ₐ” as used herein may be:
deuterium, —F, —Cl, —Br, —I, a hydroxyl group, a cyano group, or a nitro group;
a C₁-C₆₀ alkyl group, a C₂-C₆₀ alkenyl group, a C₂-C₆₀ alkynyl group, or a C₁-C₆₀ alkoxy group, each unsubstituted or substituted with deuterium, —F, —Cl, —Br, —I, a hydroxyl group, a cyano group, a nitro group, a C₅-C₆₀ carbocyclic group, a C₁-C₆₀ heterocyclic group, a C₆-C₆₀ aryloxy group, a C₆-C₆₀ arylthio group, a C₇-C₆₀ arylalkyl group, a C₂-C₆₀ heteroarylalkyl group, —Si(Q₁₁)(Q₁₂)(Q₁₃), —N(Q₁₁)(Q₁₂), —B(Q₁₁)(Q₁₂), —C(═O)(Q₁₁), —S(═O)₂(Q₁₁), —P(═O)(Q₁₁)(Q₁₂), or a combination thereof;
a C₅-C₆₀ carbocyclic group, a C₁-C₆₀ heterocyclic group, a C₆-C₆₀ aryloxy group, a C₆-C₆₀ arylthio group, a C₇-C₆₀ arylalkyl group, or a C₂-C₆₀ heteroarylalkyl group, each unsubstituted or substituted with deuterium, —F, —Cl, —Br, —I, a hydroxyl group, a cyano group, a nitro group, a C₁-C₆₀ alkyl group, a C₂-C₆₀ alkenyl group, a C₂-C₆₀ alkynyl group, a C₁-C₆₀ alkoxy group, a C₃-C₆₀ carbocyclic group, a C₁-C₆₀ heterocyclic group, a C₆-C₆₀ aryloxy group, a C₆-C₆₀ arylthio group, a C₇-C₆₀ aryl alkyl group, a C₂-C₆₀ heteroaryl alkyl group, —Si(Q₂₁)(Q₂₂)(Q₂₃), —N(Q₂₁)(Q₂₂), —B(Q₂₁)(Q₂₂), —C(═O)(Q₂₁), —S(═O)₂(Q₂₁), —P(═O)(Q₂₁)(Q₂₂), or a combination thereof; or
—Si(Q₃₁)(Q₃₂)(Q₃₃), —N(Q₃₁)(Q₃₂), —B(Q₃₁)(Q₃₂), —C(═O)(Q₃₁), —S(═O)₂(Q₃₁), or —P(═O)(Q₃₁)(Q₃₂).

In the specification, Q₁ to Q₃, Q₁₁ to Q₁₃, Q₂₁ to Q₂₃, and Q₃₁ to Q₃₃ may each independently be: hydrogen; deuterium; —F; —Cl; —Br; —I; a hydroxyl group; a cyano group; a nitro group; a C₁-C₆₀ alkyl group; a C₂-C₆₀ alkenyl group; a C₂-C₆₀ alkynyl group; or a C₁-C₆₀ alkoxy group;
a C₃-C₆₀ carbocyclic group, a C₁-C₆₀ heterocyclic group, a C₇-C₆₀ arylalkyl group, or a C₂-C₆₀ heteroarylalkyl group, each unsubstituted or substituted with deuterium, —F, cyano group, a C₁-C₆₀ alkyl group, a C₁-C₆₀ alkoxy group, a phenyl group, a biphenyl group, or a combination thereof.

The term “heteroatom” as used herein refers to any atom other than a carbon atom. Examples of the heteroatom are O, S, N, P, Si, B, Ge, Se, and a combination thereof.

The term “biphenyl group” as used herein refers to “a phenyl group substituted with a phenyl group.” In other words, the “biphenyl group” may be a substituted phenyl group having a C₆-C₆₀ aryl group as a substituent.

The term “terphenyl group” as used herein refers to “a phenyl group substituted with a biphenyl group.” In other words, the “terphenyl group” may be a substituted phenyl group having, as a substituent, a C₆-C₆₀ aryl group substituted with a C₆-C₆₀ aryl group.

The number of carbon atoms in the definitions are illustrative only. In an embodiment, the carbon number of 60 in the C₁-C₆₀ alkyl group is an example, and the definition of the alkyl group is equally applied to a C₁-C₂₀ alkyl group. The same applies to other cases.

Hereinafter, for example, a nanocapsule, a composition, a film, etc. of the disclosure will be described in more detail.

### EXAMPLES

### Preparation of Nanocapsules

In each of three vials, 7 g of acrylonitrile (AN), 3 g of methyl methacrylate (MMA), and 1 g of benzenesulfonyl hydrazide (BSH), which is a core, were thoroughly stirred and mixed.

After adding each mixture to 100 g of deionized water in three flasks each fitted with a condenser under nitrogen purging, while stirring at 250 rotations per minute (rpm) at 85° C., a potassium persulfate (KPS) aqueous solution (10 grams (g) of deionized water, 0.1 g of KPS) was slowly added thereto. Then, each of the three reactions was allowed to proceed for 2 hours, 3 hours, and 4 hours, respectively.

The prepared solutions were washed three times using a centrifuge (6000 rpm, 30 min). Finally, a freeze-dryer was used for three days to remove moisture from the sample. The size of the nanoparticles prepared by the preparation method was about 240 nm to 360 nm, as determined by measurement with a scanning electron microscope (SEM). The thickness of the shell was about 60 nm, as determined by SEM.

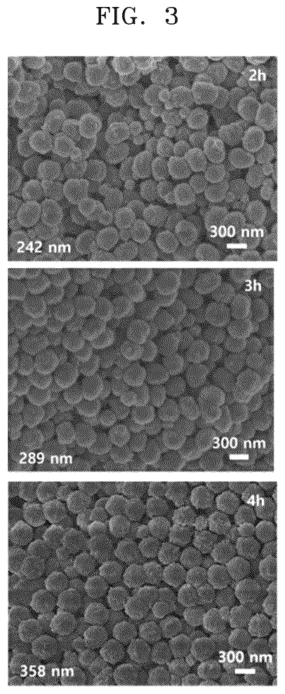

The nanocapsules were photographed using a scanning electron microscope (SEM) and are shown in FIG. 3 (sizes of nanoparticles: 242 nm, 289 nm, and 358 nm).

The synthesis method is a surfactant-free emulsion polymerization method, which is a method of polymerization by an anionic initiator which both initiates radicals and acts as an emulsifier (no crosslinker is added). The advantages of surfactant-free emulsion polymerization methods include stable particle formation without surfactants and ease of large-scale synthesis. Also, the size can be scaled based on compositing time.

### Confirmation of Nanocapsule Gas Generation Ability

Density of the nanocapsules was evaluated to confirm the gas generation ability by heat treatment.

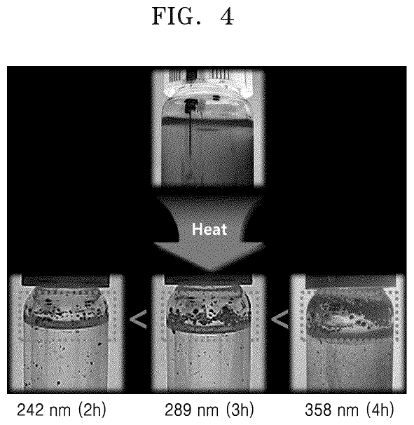

First, 10 g of deionized water was added to 0.01 g of nanocapsules that had been heat-treated at 100° C. and the density was evaluated. After the heat treatment, it was observed that the density of the particles decreased due to the generation of nitrogen, causing most of the particles to migrate toward the surface of the water, and the degree of expansion of the core increased with the increase of the particle size, causing more particles to migrate. The effects of the gas generation are shown in FIG. 4.

### Preparation of Compositions Containing Nanocapsules

Three reaction mixtures were prepared by adding the nanocapsules in an amount effective to provide 1 wt %, 2 wt %, and 5 wt %, based on the total weight of the composition (size: 358 nm) to 2-ethylhexyl acrylate (2-EHA), a monomer of optically clear resin (OCR), and stirred for 6 hours to pre-disperse.

An OCR (Youngwoo company, contains a crosslinkable monomer and an initiator) was further added to each of the pre-dispersed nanocapsule reaction mixtures and stirred for about 30 minutes using a paste mixer so that the nanocapsules were completely mixed with the OCR to prepare each composition.

A sample of each of the resulting compositions was freeze-dried after the synthesis of particles. After confirming the dispersibility of the pre-dispersed nanocapsules after freeze-drying, it was confirmed that the freeze-dried 5 wt % nanocapsules exhibited fewer agglomerated particles than the vacuum-dried 5 wt % nanocapsules.

### Film Manufacturing

Each of the compositions was coated on a glass substrate to a thickness of 10 μm using a doctor blade, cured (4 Joules (J)) by UV light to form a first layer, which is a nanocapsule layer, and then an OCA film (TMS Co,: 100 μm thick) was bonded to prepare a film.

The debonding adhesiveness of each film was measured under heating conditions (100° C., 1 minute), and results thereof are shown in Table 1 below.

TABLE 1

| | Nanocapsule | | | |
|---|---|---|---|---|
| | concentration | | Initial | Debonding |
| | (wt %) | Pure OCA | adhesion | adhesiveness |
| Adhesiveness | 1 | 1.22 | 1.53 | 0.22 |
| (Newtons per | | (100%) | (+25.4%) | (−85.6%) |
| millimeter | 2 | | 1.43 | 0.18 |
| (N/mm)) | | | (+17.2%) | (−87.4%) |
| (% change) | 5 | | 1.35 | 0.16 |
| | | | (+10.7%) | (−88.2%) |

Pure OCA is the adhesiveness of OCA without the formation of a nanocapsule layer.

Referring to the results of Table 1, it can be seen that the debonding performance is increased as the amount of nanocapsule is increased.

All films with nanocapsule concentrations of 1 wt %, 2 wt %, and 5 wt % showed an optical transmittance of 99.4% or more compared to pure OCA.

### Manufacture of Laminated Structures Including Films and Substrates

1) The composition (5 wt % nanocapsule) was coated on a display panel to a thickness of 10 μm using a doctor blade and cured (4J) by UV to form a first nanocapsule layer, and then the composition (1 wt % nanocapsule) was coated to a thickness of 10 μm using a doctor blade, and then cured (4J) by UV light to form a second nanocapsule layer.

Next, an OCA film (TMS Co.: 100 μm thick) was brought into contact therewith to prepare a laminated structure A in which a display panel and a film were adhered. The film included a two-layer nanocapsule layer and the nanocapsule layer was in direct physical contact with the display panel.

2) The composition (5 wt % nanocapsule) was coated to a thickness of 10 μm on a display panel using a doctor blade to form a one-layer nanocapsule layer.

Subsequently, an OCA film (Youngwoo Co.: 100 μm thick) was brought into contact therewith, and then cured (4J) by UV light to prepare a laminated structure B in which a display panel and a film were adhered. The film included a one-layer nanocapsule layer and the nanocapsule layer was in direct physical contact with the display panel.

For the nanocapsule layer, nanocapsules were dispersed in OCR and a doctor blade was used. In other embodiments, nanocapsules may be dispersed in a general solvent and sprayed with a spray coater, or nanocapsules may be dispersed in a general solvent and applied using a doctor blade.

### Evaluation of Peeling of Laminated Structures Including Films and Substrates

The display panel side, which is the back side of each of the laminated structures A and B in which the display panel and the film (width: 20 mm, length: 50 mm) were bonded, was heat treated at 100° C. using a heating gun (30 seconds (s)) and then subjected to a 180° peel test according to ASTM D3359 using a universal testing machine (Rework can be done similarly except for using a universal testing machine (UTM)).

Debonding adhesiveness was measured and results thereof are shown in Table 2 below.

TABLE 2

| Laminated | | Initial | Debonding |
|---|---|---|---|
| structure | Pure OCA | adhesiveness | adhesiveness |
| A | 1.18 (100%) | 1.29 (+9%) | 0.04 (−97%) |
| B | 0.47 (100%) | 0.45 (−4%) | 0.01 (−98%) |

Pure OCA is the adhesiveness of OCA without the formation of a nanocapsule layer.

It may be seen that both of the stacked structures A and B were easily peeled off with nitrogen gas generated by decomposition of the thermally decomposable compound in the core of the nanocapsule by mild heat. In addition, there was no damage to the display panel.

The heat peeling process described above is one method for heat treatment of the display panel side, which is the back side. Other suitable methods include a method of heat treatment on the film side (front direction) followed by peeling off, or a method of heat treatment on the film side (front direction) at 100° C. as a pretreatment for a certain period of time (for example, 30 s) followed by peeling-off while heating using a heating gun. In the case of heat treatment on the back side, that is, on the display panel side, it may take less time for peeling than in the case of heat treatment on the film side (front direction).

The laminated structure to which the display panel and the film are bonded can constitute a display unit of an electronic apparatus, and since such an electronic apparatus can be easily manufactured by a known method, specific details will be omitted.

When a film containing a nanocapsule layer formed of a composition containing nanocapsules according to an embodiment is bonded such that the nanocapsule layer comes into contact with a substrate and then heat is applied, gas is generated from the nanocapsule, and the film and the substrate are efficiently debonded.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A nanocapsule comprising a core-shell structure, the nanocapsule comprising:
a core comprising a thermally decomposable compound; and
a shell comprising a polymer.

2. The nanocapsule of claim 1, wherein
the thermally decomposable compound comprises a moiety that decomposes at a temperature of about 50° C. to about 200° C. to generate gas.

3. The nanocapsule of claim 2, wherein
the moiety comprises at least one of a hydrazide group, a hydroxyl group, or a combination thereof.

4. The nanocapsule of claim 1, wherein
the thermally decomposable compound comprises R¹CO—NHNH₂, R²SO₂—NHNH₂, R³R⁴P(O)—NHNH₂, M(OH)ₘ, or a combination thereof, wherein
M is a metal,
m is an integer from 1 to 5,
R¹ to R⁴ each independently comprise a C₁-C₆₀ alkyl group unsubstituted or substituted with at least one R₁₀ₐ, a C₂-C₆₀ alkenyl group unsubstituted or substituted with at least one R₁₀ₐ, a C₂-C₆₀ alkynyl group unsubstituted or substituted with at least one R₁₀ₐ, a C₁-C₆₀ alkoxy group unsubstituted or substituted with at least one R₁₀ₐ, a C₃-C₆₀ carbocyclic group unsubstituted or substituted with at least one R₁₀ₐ, or a C₁-C₆₀ heterocyclic group unsubstituted or substituted with at least one R₁₀ₐ,
R₁₀ₐ is:
deuterium (-D), —F, —Cl, —Br, —I, a hydroxyl group, a cyano group, or a nitro group;
a C₁-C₆₀ alkyl group, a C₂-C₆₀ alkenyl group, a C₂-C₆₀ alkynyl group, or a C₁-C₆₀ alkoxy group, each unsubstituted or substituted with deuterium, —F, —Cl, —Br, —I, a hydroxyl group, a cyano group, a nitro group, a C₃-C₆₀ carbocyclic group, a C₁-C₆₀ heterocyclic group, a C₆-C₆₀ aryloxy group, a C₆-C₆₀ arylthio group, a C₇-C₆₀ arylalkyl group, a C₂-C₆₀ heteroarylalkyl group, —Si(Q₁₁)(Q₁₂)(Q₁₃), —N(Q₁₁)(Q₁₂), —B(Q₁₁)(Q₁₂), —C(═O)(Q₁₁), —S(═O)₂(Q₁₁), —P(═O)(Q₁₁)(Q₁₂), or a combination thereof;
a C₃-C₆₀ carbocyclic group, a C₁-C₆₀ heterocyclic group, a C₆-C₆₀ aryloxy group, a C₆-C₆₀ arylthio group, a C₇-C₆₀ arylalkyl group, or a C₂-C₆₀ heteroarylalkyl group, each unsubstituted or substituted with deuterium, —F, —Cl, —Br, —I, a hydroxyl group, a cyano group, a nitro group, a C₁-C₆₀ alkyl group, a C₂-C₆₀ alkenyl group, a C₂-C₆₀ alkynyl group, a C₁-C₆₀ alkoxy group, a C₃-C₆₀ carbocyclic group, a C₁-C₆₀ heterocyclic group, a C₆-C₆₀ aryloxy group, a C₆-C₆₀ arylthio group, a C₇-C₆₀ arylalkyl group, a C₂-C₆₀ heteroarylalkyl group, —Si(Q₂₁)(Q₂₂)(Q₂₃), —N(Q₂₁)(Q₂₂), —B(Q₂₁)(Q₂₂), —C(═O)(Q₂₁), —S(═O)₂(Q₂₁), —P(═O)(Q₂₁)(Q₂₂), or a combination thereof; or
—Si(Q₃₁)(Q₃₂)(Q₃₃), —N(Q₃₁)(Q₃₂), —B(Q₃₁)(Q₃₂), —C(═O)(Q₃₁), —S(═O)₂(Q₃₁), or —P(═O)(Q₃₁)(Q₃₂), wherein
Q₁₁ to Q₁₃, Q₂₁ to Q₂₃, and Q₃₁ to Q₃₃ are each independently: hydrogen; deuterium; —F; —Cl; —Br; —I; a hydroxyl group; a cyano group; a nitro group; a C₁-C₆₀ alkyl group; a C₂-C₆₀ alkenyl group; a C₂-C₆₀ alkynyl group; a C₁-C₆₀ alkoxy group; or a C₃-C₆₀ carbocyclic group, a C₁-C₆₀ heterocyclic group, a C₇-C₆₀ arylalkyl group, or a C₂-C₆₀ heteroarylalkyl group, each unsubstituted or substituted with deuterium, —F, cyano group, a C₁-C₆₀ alkyl group, a C₁-C₆₀ alkoxy group, a phenyl group, a biphenyl group, or a combination thereof.

5. The nanocapsule of claim 1, wherein
the thermally decomposable compound comprises benzenesulfonyl hydrazide, p-toluenesulfonyl hydrazide, acetylhydrazide, 2,4,6-triisopropylbenzenesulfonylhydrazide, zinc hydroxide, or a combination thereof.

6. The nanocapsule of claim 1, wherein
the polymer of the shell comprises a polymer formed from a monomer comprising a vinyl group.

7. The nanocapsule of claim 6, wherein
the monomer comprises methyl methacrylate, acrylonitrile, 2-ethylhexyl acrylate, butyl acrylate, vinyl acetate, ethyl acrylate, methyl acrylate, benzyl acrylate, phenoxyethyl acrylate, acrylic acid, hydroxyethyl methacrylate, glycidyl methacrylate, acetoacetoxyethyl methacrylate, 2-hydroxyethyl acrylate, isobornyl acrylate, octadecyl methacrylate, or a combination thereof.

8. The nanocapsule of claim 1, wherein
the polymer of the shell is a non-crosslinkable polymer.

9. The nanocapsule of claim 1, wherein
the thermally decomposable compound is decomposed by heat to generate nitrogen or H₂O (g).

10. The nanocapsule of claim 1, wherein
a size of the nanocapsule is about 100 nanometers to about 500 nanometers.

11. A composition comprising:
the nanocapsule of claim 1;
a crosslinkable monomer; and
an initiator.

12. The composition of claim 11, wherein
the crosslinkable monomer comprises a vinyl group.

13. The composition of claim 12, wherein
an amount of the nanocapsule is about 0.1 weight percent to about 10 weight percent (based on the total weight of the composition).

14. The composition of claim 12, wherein
the crosslinkable monomer comprises 2-ethylhexyl acrylate, butyl acrylate, vinyl acetate, methyl methacrylate, ethyl acrylate, methyl acrylate, benzyl acrylate, phenoxyethyl acrylate, acrylic acid, hydroxyethyl methacrylate, glycidyl methacrylate, acetoacetoxyethyl methacrylate, 2-hydroxyethyl acrylate, isobornyl acrylate, or a combination thereof.

15. A film comprising a nanocapsule layer formed using the composition of claim 11 and an optically clear adhesive.

16. The film of claim 15, wherein
a thickness of the nanocapsule layer is about 1 micrometers to about 30 micrometers.

17. The film of claim 15, wherein
the film has a thickness of about 20 micrometers to about 200 micrometers.

18. An electronic apparatus comprising:
a first substrate;
a second substrate opposed to the first substrate; and
a film disposed between the first substrate and the second substrate, wherein
the film is the film of claim 15.

19. The electronic apparatus of claim 18, wherein
the nanocapsule layer contacts at least one of the first substrate, the second substrate, or both the first substrate and the second substrate.

20. The electronic apparatus of claim 18, wherein
the first substrate and the second substrate each independently comprise a display panel, a touch panel, a polarizing plate, or tempered glass.
